(19) United States
(12) Patent Application Publication
(10) Pub. No.: US 2023/0200316 A1
(43) Pub. Date: Jun. 29, 2023

(54) SELECTIVELY CONTROLLABLE IRRIGATION SYSTEMS

(71) Applicant: Clint Echevarria, Cottonwood Heights, UT (US)

(72) Inventor: Clint Echevarria, Cottonwood Heights, UT (US)

(21) Appl. No.: 18/145,707

(22) Filed: Dec. 22, 2022

Related U.S. Application Data
(60) Provisional application No. 63/307,447, filed on Feb. 7, 2022.
(60) Provisional application No. 63/265,960, filed on Dec. 23, 2021.

(51) Int. Cl. A01G 25/16

(52) U.S. Cl. CPC A01G 25/16

(57) ABSTRACT

The present disclosure generally relates to irrigation systems. More particularly, but not exclusively, the present disclosure relates to individually controlling operation or functionality of one or more irrigation heads in an irrigation system that includes a number of irrigation heads. In one form, an irrigation system includes a number of irrigation heads and at least a first irrigation head of the number of irrigation heads includes a wireless transceiver. The system also includes a program module configured to wirelessly connect with the wireless transceiver of the first irrigation head. At least one operational aspect of the first irrigation head is controllable by the program module independent of the other irrigation heads of the number of irrigation heads.

### CROSS-REFERENCE TO RELATED APPLICATIONS

This application claims the benefit of U.S. Patent Application Ser. Nos. 63/307,447, filed on Feb. 7, 2022 and 63/265,960, filed on Dec. 23, 2021; the disclosures of which are incorporated herein by reference in their entirety.

### TECHNICAL FIELD

The present disclosure generally relates to irrigation systems. More particularly, but not exclusively, the present disclosure relates to individually controlling operation or functionality of one or more irrigation heads in an irrigation system that includes a number of irrigation heads.

### BACKGROUND

Unless otherwise indicated herein, the materials described herein are not prior art to the claims in the present application and are not admitted to be prior art by inclusion in this section.

Irrigation systems may be used for a variety of different purposes. For example, irrigation systems may be employed for large scale operations such as commercial farming, or they may be used for lawns including grass and/or for other agricultural operations. In some forms, irrigation systems may include a number of individual irrigation heads which are configured to dispense water to different areas or zones within the locus where the irrigation system is implemented. In some instances, one or more issues may arise with respect to operation of one or more irrigation heads in an irrigation system. For example, an irrigation head may not adequately irrigate, or may over irrigate, an intended zone, or may irrigate at a time where the irrigation provides less than optimal benefit. As water scarcity increases in many areas, issues with current irrigation systems is increasingly undesirable. As such, there remains a need for advancements in this area of technology.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, an irrigation system includes a number of irrigation heads. At least a first irrigation head of the number of irrigation heads includes a wireless transceiver. The system also includes a program module configured to wirelessly connect with the wireless transceiver of the first irrigation head. At least one operational aspect of the first irrigation head is controllable by the program module independent of the other irrigation heads of the number of irrigation heads.

In another embodiment, a method includes identifying a first irrigation head from a number of irrigation heads; determining at least one operational aspect of the first irrigation head; wirelessly communicating with the first irrigation head and providing the determined at least one operational aspect of the first irrigation head to the first irrigation head; and operating the first irrigation head in accordance with the determined at least one operational aspect of the first irrigation head.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict one non-limiting typical embodiment of the invention and are therefore not to be considered limiting of its scope. The invention will be described and explained with additional specificity and detail through the use of the accompanying drawings in which:

FIG. 1 is a schematic illustration of an irrigation system;

FIG. 2 is a schematic illustration of a method for operating an irrigation head in the system illustrated in FIG. 1; and

FIG. 3 illustrates an example computing system.

### DETAILED DESCRIPTION

The present disclosure generally relates to irrigation systems. More particularly, but not exclusively, the present disclosure relates to control of irrigation heads in an irrigation system. In one aspect for example, the present disclosure relates to individually controlling operation or functionality of one or more irrigation heads in an irrigation system that includes a number of irrigation heads. Stated alternatively, one or more functions or operational aspects of one or more irrigation heads in an irrigation system may be controlled independent of the functions or operational aspects of the other irrigation heads in the irrigation system. By way of example, independent control of individual irrigation heads in the irrigation system may allow for highly controllable irrigation systems that provide increased efficiency and reduce water usage and waste, amongst other things.

In one aspect, the irrigation heads in the irrigation system may be wirelessly coupled or connected with a program module remotely positioned from the irrigation heads and/or the irrigation system itself, although forms in which wired or partially wired coupling or connecting are employed are also possible. In one form, the irrigation head may include a wireless transceiver that facilitates communication with the program module through a Wi-Fi or Bluetooth connection, although other variations are possible and contemplated. The program module may be provided as a program on a computer and/or as an application on a smartphone, although other variations are possible. The device on which the program module is provided may communicate directly or indirectly with the irrigation head.

The program module may provide controls signals, which may be automatically generated or generated in response to manual input received at the program module, to the irrigation head to control one or more operational aspects of functions of the irrigation head. In turn, the irrigation head may be configured to respond to the control signals in order to implement or change an operational aspect or function thereof. For example, in response to a control signal indicating that the irrigation head should dispense less water during a given time period, the irrigation head may be configured to reduce its operation time and/or restrict the amount of water released therefrom during a period of time.

The irrigation head may control these and other operational aspects or functions through any suitable manner or technique. For example, in some forms, the irrigation head may include a configurable valve that controls the amount of time in which it is open and the amount of water which is dispensed therefrom. In some forms, the irrigation head may additionally or alternatively be configured to change the pattern for the water which is dispensed therefrom in order to change the area which is being irrigated by the irrigation head. For example, the area may be increased or decreased, or the spray pattern may be changed to better target one or more portions in the area where no water or insufficient water is being provided. These and additional and/or alternative manners and techniques by which the irrigation head may be controlled will be discussed below.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

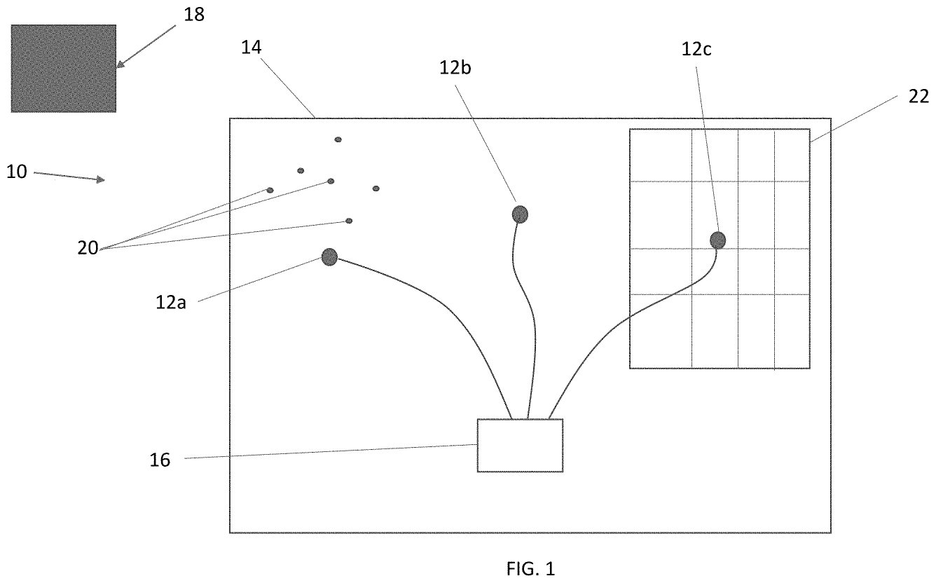

FIG. 1 provides a schematic illustration of an irrigation system 10 which includes a plurality of irrigation heads 12a-c, each of which is configured to dispense water to provide irrigation to a respective portion or zone of the location 14 where the system 10 is installed. By way of non-limiting example, the location 14 may be representative of a lawn which includes portions of grass that will be irrigated by the system 10. Still, it should be appreciated that the system 10 and the concepts discussed herein may be applicable to irrigation systems used in different settings and/or for different purposes. For example, such alternative irrigation systems may include those used to water plants such as shrubs or trees, or those which are configured to water or irrigate crops on either a large scale or a small scale, such as a garden.

In addition to the irrigation heads 12a-c, the system 10 may include a zone header or control box 16 which is coupled to each of the irrigation heads 12a-c. For example, the control box 16 may independently provide a water supply to each of the irrigation heads 12a-c. Alternatively, water may be provided from the control box 16 to one of the irrigation heads 12a-c and then on to the others of the irrigation heads 12a-c in an arrangement where each of the irrigation heads 12a-c is not directly connected to or coupled with the control box 16. However, forms in which the control box 16 is not included are also possible.

One or more of the irrigation heads 12a-c may include a wireless transceiver configured to wirelessly communicate with a program module 18 in order to provide independent and dynamic control of the one or more irrigation heads 12a-c. Forms in which the program module 18 communicates independently to one or more of the irrigation heads 12a-c utilizing a wired connection are also contemplated. In one non-limiting form, all of the irrigation heads in the system 10 may be configured to individually, and independently relative to the other irrigation heads, communicate with the program module 18. The program module 18, or the device it is hosted on, may communicate wirelessly with the irrigation heads 12a-c utilizing a Wi-Fi or Bluetooth connection, although other variations are possible. In one form for example, the irrigation heads 12a-c may be coupled to a Wi-Fi network provided at the location 14, and the program module 18 may be hosted on a remote device that communicates with the irrigation heads 12a-c through an internet connection. Additionally or alternatively, a Bluetooth connection may be utilized for communication between the program module 18 and any of the irrigation heads 12a-c within range of the program module 18. In some forms, the irrigation heads 12a-c may be provided with a cellular transmitter such that communication with the program module 18 over a cellular network is also possible. Also, it should be appreciated that the program module 18 may communicate directly or indirectly with the irrigation heads 12a-c. For example, in one non-limiting form, the control box 16 may include a transceiver or transmitter which communicates with the program module 18 and the irrigation heads 12a-c such that the control box 16 may relay messages or information therebetween.

The program module 18 may take any number of forms. In one form for example, the program module 18 may be provided in the form of a computer program or smart phone app which allows a user to select, determine and/or change one or more operational aspects of an individual irrigation head 12a-c, and may also include automated features which may determine and control operational aspects of individual irrigation heads 12a-c. The irrigation heads 12a-c may also include a controller which is responsive to signals provided by the program module 18 to change operational aspects or functions of the respective irrigation head.

It is contemplated that any number of operational aspects or functions, or any combinations thereof, of the irrigation heads 12a-c may be controlled with the program module 18, and that the irrigation heads 12a-c may be similarly fashioned to control or change any number of operational aspects thereof in response to relevant instructions provided by the control module 18. The program module 18 may facilitate selection of or change to an operational aspect or function of one or more of the irrigation heads 12a-c which includes a duration of operation of the irrigation head 12a-c. For example, it may be decided that each of the irrigation heads 12a-c should run for different periods relative to one another based on a number of factors, including for example the time of year, time of day, positioning of the irrigation heads, or a determination that one or more areas need additional or reduced watering. In response to the selection of or change to a watering duration at the program module 18, the irrigation heads 12a-c may be configured to implement operation for a period of time that satisfies the selected or changed watering duration.

The program module 18 may additionally or alternatively facilitate selection of or change to an operational aspect or function of one or more of the irrigation heads 12a-c which includes the lateral limits of a spray pattern of the irrigation heads 12a-c. By way of example, the irrigation heads 12a-c may dispense water to an area via rotation of the irrigation head from side to side, or they may include one or more spray mechanisms configured to control the side-to-side variations of a spray pattern provided by the irrigation head. In one form, the lateral limits of the spray pattern may be selected or changed with the program module 18 in response to determining that either too small or too large of an area is receiving water from one or more of the irrigation heads 12a-c. In response to receiving relevant signals from the program module 18, the one or more of the irrigation heads 12a-c may increase or decrease its rotation in order to increase or decrease the area which is watered, or in the alternative the one or more of the irrigation heads 12a-c may change positioning of the one or more spray mechanisms to broaden or narrow as the case may be, depending on whether increased area or decreased area is desired, the spray pattern from the irrigation head 12a-c. In aspects where the area which is irrigated by the respective irrigation head 12a-c is increased or decreased, the program module 18 may also change the duration of operation of the irrigation head 12a-c. For example, if the area is increased, then the duration of operation of the irrigation head 12a-c may be commensurately increased while the duration of operation of the irrigation head 12a-c may be decreased if the area is decreased so in either case the amount of water applied per unit of area remains the same.

The program module 18 may additionally or alternatively facilitate selection of or change to an operational aspect or function of one or more of the irrigation heads 12a-c which includes a degree of pitch of a spray pattern of the irrigation heads 12a-c. More specifically, the degree of pitch of the spray pattern (or angle of the spray pattern relative to the irrigation head and/or the underlying ground) may be selected or changed in the program module 18. By way of example, the irrigation heads 12a-c may include one or more spray mechanisms configured to control the degree of pitch of the spray pattern provided by the irrigation head. In one form, the degree of pitch of the spray pattern may be selected or changed with the program module 18 in response to determining that the spray pattern reaches too far away or not far enough from the irrigation head 12a-c. In response to receiving relevant signals from the program module 18, the irrigation head 12a-c may change positioning of the one or more spray mechanisms to change the degree of pitch of the spray pattern to increase or decrease the distance from the irrigation head 12a-c that the spray pattern reaches. To the extent changing the degree of pitch of the spray pattern increases or decreases the area to which water is applied by the irrigation head 112a-c, the program module 18 may also commensurately alter the duration of operation of the irrigation head 112a-c as described above such that the amount of water applied per unit of area remains the same.

The program module 18 may also facilitate selection of or change to an operational aspect or function of one or more of the irrigation heads 12a-c which includes the pressure of the water applied to or dispensed by the irrigation heads 12a-c. More specifically, the irrigation heads 12a-c may include one or more spray pressure regulators which can adjust the pressure of the water applied to or dispensed by the irrigation heads 12a-c. In response to receiving relevant signals from the program module 18, the irrigation head 12a-c may change the pressure of the water applied to or dispensed by the irrigation head 12a-c.

The program module 18 may also facilitate selection of or change to an operational aspect or function of one or more of the irrigation heads 12a-c which includes an operation schedule of the irrigation heads 12a-c. More specifically, the day, time of day and/or the duration of watering, amongst other things, at which the irrigation head 12a-c operates may be selected or changed in the program module 18. Additionally or alternatively, the operation schedule may limit or restrict the irrigation head 12a-c from operating during a specific time which may, for example, be prohibited by a municipality or otherwise be non-beneficial or less than optimal for irrigating. By way of example, it may be determined that the time of day an irrigation head 12a-c operates should be changed based on the time of the year. In response to receiving relevant signals or instructions from the program module 18, the one or more irrigation heads 12a-c may change the day, time of day and/or the duration of watering which it operates.

In one form, one or more of the irrigation heads 12a-c may include one or more LED lights and the program module 18 may also facilitate selection of or change to an operational aspect of one or more of the irrigation heads 12a-c which may include, for example, operation of the one or more LED lights. In one form for example, the program module 18 may provide control of the brightness of the one or more LEDs, the color of the one or more LEDS, and/or the time/duration when the one or more LEDs is illuminated. In one form, the one or more LEDs may be configured and positioned relative to the irrigation head 12a-c in manner such that the water in the spray pattern from the irrigation head 12a-c is illuminated by the one or more LEDs.

In one form, the program module 18 may be configured to communicate with a weather forecasting module (not shown) and determine an operational schedule for one or more of the irrigation heads 12a-c which is tailored based on the forecasted weather report. The program module 18 may be further configured to provide the operational schedule which is tailored to or accounts for the forecasted weather report to the one or more of the irrigation heads 12a-c. In turn, the one or more of the irrigation heads 12a-c may change an operational aspect thereof based on the provided operational schedule. By way of non-limiting example, in one form if the forecasted weather report is indicative of precipitation on a given day and in a given period of time, the program module 18 may modify the operational schedule of the one or more of the irrigation heads 12a-c such that operation of the one or more of the irrigation heads 12a-c is prevented during the forecasted precipitation period. The program module 18 may also modify the operational schedule of one or more of the irrigation heads 12a-c to account for the amount of precipitation forecasted and/or received for a given location. For example, if a large amount of precipitation is forecasted and/or received, the program module 18 may modify the operational schedule of the one or more of the irrigation heads 12a-c to delay operation for several days to account for the large amount of precipitation recently forecasted or recently received. By way of further example, in one form if the forecasted weather report is indicative of conditions likely to result in high evaporation rates on a given day and/or in a given period of time, the program module 18 may modify the operational schedule of the one or more of the irrigation heads 12a-c such that operation of the one or more of the irrigation heads 12a-c is accelerated or delayed to avoid watering on the given day and/or during the given period of time in which high evaporation rates are likely.

The system 10 may also include a number of sensors 20 which are associated with and configured to wirelessly communicate with one of the irrigation heads 12a-c and/or the program module 18. With reference to FIG. 1 for example, the sensors 20 are associated with the irrigation head 12a and may be configured to sense characteristics of the operation of the irrigation head 12a, although additional sensors 20 may be associated with a respective one of the irrigation heads 12b and 12c and may be configured to sense characteristics of the operation of the respective irrigation head 12b or 12c, respectively. Information from the characteristics of the operation of the irrigation head 12a by the sensors 20 may then be communicated to the irrigation head 12a and/or the program module 18. In one form for example, the sensors 20 may be configured to measure the amount of water provided by the irrigation head 12a in a given period of time.

In forms where the sensors communicate with the irrigation head 12a, the irrigation head 12a may further provide this information to the program module 18. The program module 18 may be further configured to change the at least one operational aspect of the irrigation head 12a in response to the information collected by the sensors 20. For example, if the sensors 20 all provide information indicating that the amount of water measured at each sensor is above or below a desired or targeted amount, the program module 18 may be configured to change one or more operational aspects of the irrigation head 12a (in a manner described above for example) in order to either reduce or increase the amount of water that is provided by the irrigation head 12a in a given period of time to achieve the desired or targeted amount. As another example, if one or more of the sensors 20 indicates that the amount of water measured at the respective sensor 20 is above or below a desired or targeted amount, while others of the sensors 20 indicate that the amount of water measured corresponded to the desired or targeted amount, it may be indicative that the irrigation head 12a is not evenly irrigating an area intended to be irrigated by the irrigation head 12a. In response, the program module 18 may be configured to change one or more operational aspects of the irrigation head 12a (in a manner described above for example) in order to change the spray pattern or other aspects of the irrigation head 12a as necessary in order to more evenly irrigate across the intended area. In one form, modifications or changes to one or more operational aspects of the irrigation head 12a based on information provided by the sensors 20 may occur automatically and in real time.

In one form, one or more of the irrigation heads 12a-c may be configured to determine if there is a leak associated therewith. For example, one or more of the irrigation heads 12a-c may include a meter which measures water flow therethrough. The irrigation head(s) 12a-c may also be configured to determine if there is water flow through the meter at times when the irrigation head(s) 12a-c is/are not in an operational state. For example, if the meter of the irrigation head 12a-c measures water flow but the irrigation head 12a-c has not been activated or placed in an operational state, then the irrigation head 12a-c may determine that water is flowing through it. In instances where there is water flow through the meter and the irrigation head 12a-c is not in an operational state, the irrigation head 12a-c may determine that there is a leak associated therewith and/or that the irrigation head 12a-c is not properly functions. For example, the irrigation head 12a-c may be operating (by releasing or distributing water) despite not be activated to do so. In response, the irrigation head 12a-c may be further configured to transmit a leak notification to the program module 18, and the program module 18 may automatically create and transmit a leak notification and repair request so that the irrigation head 12a-c may be serviced to address the suspected water leak.

Additionally or alternatively, in response to receiving a leak notification, or otherwise determining the presence of a leak or suspected leak, the program module 18 may be configured to automatically cease operation of the system 10 in its entirety, or it may be configured to cease operation of only a portion the system 10 in order to prevent any further water waste. For example, in one form, if the program module 18 receives a leak notification, or otherwise determines the presence of a leak or suspected leak, the program module 18 may be configured to prevent water flow to one or more of the irrigation heads 12a-c, including the irrigation head 12a-c which has indicated the presence of a leak or suspected leak.

In one aspect, when one or more of the irrigation heads 12a-c includes a meter, the meter may be configured to determine the amount of water that flows through the respective irrigation head during a period of time. For example, the meter could determine the amount of water that flows through the respective irrigation head 12a-c over the course of 1, 2, 3, 4, 5, 6, 7 or 8 hours, amongst other variations, or over the course of 0.5, 1, 1.5, 2.0, etc. days, although variations are again possible. The amount of water that flows through the respective irrigation head 12a-c as measured by the meter may transmitted to the program module 18.

The system 10 may also be configured to determine the amount of water that has been distributed individually to each of the irrigation heads 12a-c over a corresponding period of time, or collectively to the irrigation heads 12a-c over the corresponding period of time. For example, the zone header or control box 16 may include one or more meters configured to measure the amount of water provided to each of the irrigations heads 12a-c individually, or to the irrigation heads 12a-c collectively. The one or more meters may also be configured to measure the amount of water provided to a combination of the irrigation heads 12a-c which includes less than all of the irrigation heads 12a-c. For example, the one or more meters may determine the amount of water which is provided to the irrigation heads 12a and 12b, 12a and 12c, and so on.

The amount of water provided to one or more of the irrigation heads 12a-c as measured by the one or more meters associated with the zone header or control box 16 may be transmitted to the program module 18. The program module 18 may also be further configured to determine if the amount of water provided to the one or more irrigation heads 12a-c, as determined by the one or more meters associated with the zone header or control box 16, is greater than the amount of water that flows through the respective irrigation head 12a-c as measured by the meter associated with the irrigation head. If the amount is greater, then the program module 18 may be further configured to determine that a leak has occurred at a location between the irrigation head 12a-c and the zone header or control box 16.

By way of further illustrative example, if a meter associated with the irrigation head 12a indicates that one hundred gallons of water has flowed through the irrigation head 12a, and a meter associated with the zone header or control box 16 indicates that two hundred gallons of water has been provided to the irrigation head 12a, then the program module 18 may determine that a leak exists between the irrigation head 12a and the control box 16. As another further illustrative example, if one or more meters associated with the irrigation heads 12a-c indicate that one hundred gallons of water has flowed through the irrigation heads 12a-c collectively, and a meter associated with the zone header or control box 16 indicates that two hundred gallons of water has been provided to the irrigation heads 12a-c collectively, then the program module 18 may determine that a leak exists between the irrigation heads 12a-c and the control box 16.

In response to determining that a leak is present between the control box 16 and the irrigation head(s) 12a-c, the program module 18 may be further configured to prevent additional water supply to the irrigation head(s) 12a-c and/or may automatically create and transmit a leak notification and repair request so that the system 10 may be serviced to address the suspected water leak between the irrigation head(s) 12a-c and the control box 16.

In one form, when the operational aspect of the irrigation head 12a-c includes selecting or modifying a coverage area provided by the respective irrigation head 12a-c, a laser gridding operation may be performed to determine if any portion(s) within an area intended to be irrigated by the respective irrigation head 12a-c is/are not receiving proper irrigation. With respect to FIG. 1 for example, an exemplary laser grid 22 is illustrated with respect to the irrigation head 12c. In this form, the irrigation head 12c may be operated and areas within the laser grade 22 may be assessed to determine if they are receiving water from the irrigation head 12c. In the event one or more areas within the laser grid 22 are not receiving water from the irrigation head 12c, then one or more operational aspects of the irrigation head 12c may be modified (in one or more of the manners described above for example) in order to provide desired irrigation coverage to the entire zone.

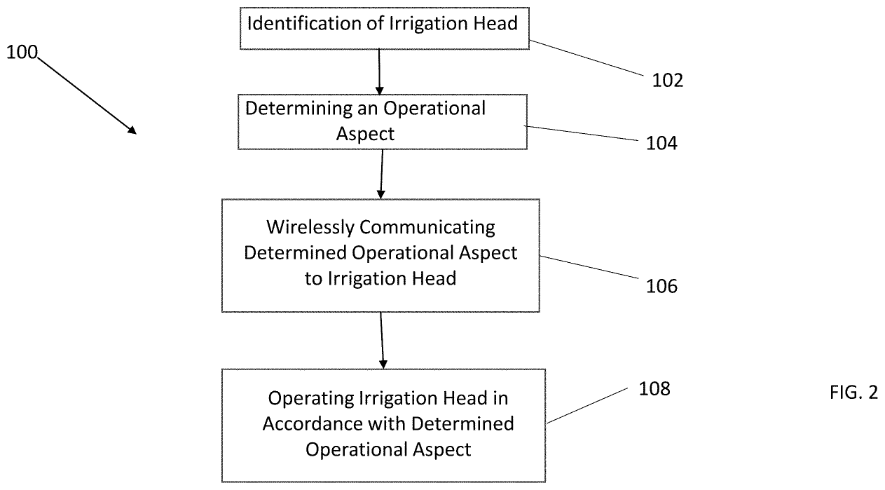

FIG. 2 is a flowchart of an example method 100 for operating an irrigation head. The method 100 may be arranged in accordance with at least one embodiment described in the present disclosure. One or more of the operations of the method 100 may be performed, in some embodiments, by a device or system, and may be performed automatically and in real time without any user intervention or input. In these and other embodiments, the method 100 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 100 may include block 102 at which a first irrigation head from a plurality of irrigation heads may be identified. For example, as indicated above, one of the irrigation heads 12a-c in the system 10 may be identified either wirelessly or otherwise to facilitate communication between it and the program module 18. At block 104, an operational aspect of the identified irrigation head may be determined. In one form for example, the operational aspect may be automatically determined by the program module 18 and/or manually input into the program module 18. It is contemplated that the operational aspect of the irrigation head could include a number of different parameters, some of which have been identified herein above. For example, the operational aspect may relate to operation time/duration, coverage area provided by the irrigation head, and/or characteristics of a spray pattern provided by the irrigation head.

At block 106, the determined operational aspect of the irrigation head may be wirelessly communicated to the irrigation head, although forms in which the determined operational aspect of the irrigation head are provided to the irrigation head in different manners are also contemplated. At block 108, the irrigation head may be operated in accordance with the determined operational aspect which is communicated thereto. For example, one or more aspects of the irrigation head may be changed in order to operate in accordance with the determined operational aspect.

Modifications, additions, or omissions may be made to the method 100 without departing from the scope of the present disclosure. For example, some of the operations of method 100 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments. For example, in some embodiments, the method 100 may include one or more of the operations described above or elsewhere in this document.

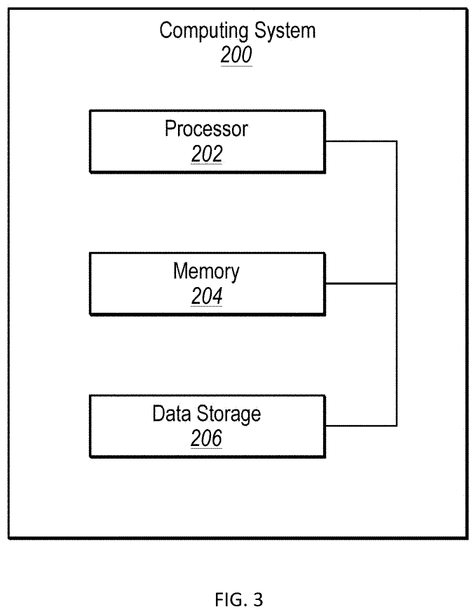

FIG. 3 illustrates a block diagram of an example computing system 200. The computing system 200 may be configured according to at least one embodiment of the present disclosure and may be an example of computing systems that may include or be part of one or more elements of the system 10 of FIG. 1. For example, the system 10 may include one or more computing systems 200. For instance, the computing system 200 may be an example of the program module 18 of FIG. 1. The computing system 200 may include a processor 202, a memory 204, and a data storage 206. The processor 202, the memory 204, and the data storage 206 may be communicatively coupled. The processor 202 may correspond to the program module 18 described herein, and the data storage 206 may correspond to a database included in the program module 18.

In general, the processor 202 may include any suitable special-purpose or general-purpose computer, computing entity, or processing device including various computer hardware or software modules and may be configured to execute instructions stored on any applicable computer-readable storage media. For example, the processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, the processor 202 may include any number of processors configured to, individually or collectively, perform or direct performance of any number of operations described in the present disclosure. Additionally, one or more of the processors may be present on one or more different electronic devices, such as different servers.

In some embodiments, the processor 202 may be configured to interpret and/or execute program instructions and/or process data stored in the memory 204, the data storage 206, or the memory 204 and the data storage 206. In some embodiments, the processor 202 may fetch program instructions from the data storage 206 and load the program instructions in the memory 204. After the program instructions are loaded into memory 204, the processor 202 may execute the program instructions.

The memory 204 and the data storage 206 may include computer-readable storage media for carrying or having computer-executable instructions or data structures stored thereon. Such computer-readable storage media may include any available media that may be accessed by a general-purpose or special-purpose computer, such as the processor 202. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store program code in the form of computer-executable instructions or data structures and which may be accessed by a general-purpose or special-purpose computer. In these and other embodiments, the term “non-transitory” as explained herein should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

Modifications, additions, or omissions may be made to the computing system 200 without departing from the scope of the present disclosure. For example, in some embodiments, the computing system 200 may include any number of other components that may not be explicitly illustrated or described.

For instance, in some embodiments, the computing system 200 may include a communication unit that includes any component, device, system, or combination thereof that is configured to transmit or receive information over a network. In some embodiments, the communication unit may communicate with other devices at other locations, the same location, or even other components within the same system. For example, the communication unit may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a Wi-Fi device, a WiMax device, cellular communication facilities, or others), and/or the like. The communication unit may permit data to be exchanged with a network and/or any other devices or systems described in the present disclosure. For example, the communication unit may allow the computing system 200 to communicate with other systems, such as computing devices and/or other networks.

Additionally or alternatively, the computing system 200 may include one or more user interfaces in some embodiments. The user interfaces may include any system or device to allow a user to interface with the computing system 200. For example, the interfaces may include a mouse, a track pad, a keyboard, and/or a touchscreen, among other devices or systems. The interfaces may also include a graphical user interface that may be presented on a display that may be included with the computing system 200. The display may be configured as one or more displays, like an LCD, LED, or other type of display. The display may be configured to present content such as video, text, user interfaces, and other data as directed by the processor.

As indicated above, the embodiments described in the present disclosure may include the use of a special purpose or general-purpose computer (e.g., the processor 202 of FIG. 3) including various computer hardware or software modules, as discussed in greater detail below. Further, as indicated above, embodiments described in the present disclosure may be implemented using computer-readable media (e.g., the memory 204 or data storage 206 of FIG. 3) for carrying or having computer-executable instructions or data structures stored thereon.

In one embodiment, an irrigation system includes a number of irrigation heads, where at least a first irrigation head of the number of irrigation heads includes a wireless transceiver and a program module configured to wirelessly connect with the wireless transceiver of the first irrigation head. At least one operational aspect of the first irrigation head is controllable by the program module independent of the other irrigation heads of the number of irrigation heads.

In one form, the program module is configured to wirelessly connect with the wireless transceiver by a Wi-Fi or Bluetooth connection.

In another form, the at least one operational aspect of the first irrigation head includes a duration of operation of the first irrigation head.

In still another form, the at least one operational aspect of the first irrigation head includes lateral limits of a spray pattern.

In yet another form, the at least one operational aspect of the first irrigation head includes a degree of pitch of a spray pattern.

In still another form, the at least one operational aspect of the first irrigation head includes water pressure applied to the first irrigation head.

In another form, the wireless transceiver of the first irrigation head is configured to transmit a leak notification in response to detection of a leak associated with the first irrigation head.

In still another form, the at least one operational aspect of the first irrigation head includes an operation schedule of the first irrigation head.

In one aspect of this form, the operation schedule restricts operation of the first irrigation head during one or more specified periods of time.

In another form, the program module is configured to communicate with a weather forecasting module and provide a modified operational schedule to the first irrigation head based on forecasted weather reports.

In one aspect of this form, the modified operational schedule prevents operation of the first irrigation head during a forecasted precipitation period.

In another form, the system further includes a number of sensors configured to wirelessly communicate with at least one of the first irrigation head and the program module to provide information regarding operation of the first irrigation head.

In one aspect of this form, the information regarding operation of the first irrigation head includes an amount of water detected at each of the sensors during an operational period of the first irrigation head.

In a further aspect of this form, the program module is further configured to change the at least one operational aspect of the first irrigation head in response to the information.

In another form, the at least one operational aspect of the first irrigation head is coverage area provided by the first irrigation head, and the coverage area is determined in response to a laser gridding performed in connection with the first irrigation head.

In yet another form, the first irrigation head includes one or more LED lights and the at least one operational aspect of the first irrigation head includes operation of the one or more LED lights.

In one aspect of this form, the one or more LED lights are positioned to illuminate a spray pattern provided by the first irrigation head.

In another embodiment, a method includes identifying a first irrigation head from a number of irrigation heads; determining at least one operational aspect of the first irrigation head; wirelessly communicating with the first irrigation head and providing the determined at least one operational aspect of the first irrigation head to the first irrigation head; and operating the first irrigation head in accordance with the determined at least one operational aspect of the first irrigation head.

In form, determining the at least one operational aspect of the first irrigation head includes applying a laser grid to an area adjacent to the first irrigation head during operation of the first irrigation head; identifying from the laser grid one or more areas where irrigation from the first irrigation head is absent or below a predetermined value; and changing one or more operational aspects of the first irrigation head to provide or increase irrigation to the one or more identified areas.

In another form, providing the determined at least one operational aspect of the first irrigation head to the first irrigation head includes controlling a duration of operation of the first irrigation head.

In still another form, providing the determined at least one operational aspect of the first irrigation head to the first irrigation head includes controlling lateral limits of a spray pattern.

In yet another form, providing the determined at least one operational aspect of the first irrigation head to the first irrigation head includes controlling a degree of pitch of a spray pattern.

In another form, providing the determined at least one operational aspect of the first irrigation head to the first irrigation head includes adjusting water pressure applied to the first irrigation head.

In yet another form, the method further includes detecting with the first irrigation head a leak associated with the first irrigation head and transmitting a leak notification in response to detecting the leak associated with the first irrigation head.

In still another form, providing the determined at least one operational aspect of the first irrigation head to the first irrigation head includes controlling an operation schedule of the first irrigation head.

In one aspect of this form, controlling the operation schedule of the first irrigation head includes restricting operation of the first irrigation head during one or more specified periods of time.

In another form, the method includes detecting with the first irrigation head a leak associated with the first irrigation head and transmitting a leak notification in response to detecting the leak associated with the first irrigation head.

In another form, providing the determined at least one operational aspect of the first irrigation head to the first irrigation head includes providing a modified operational schedule to the first irrigation head based on forecasted weather reports.

In one aspect of this form, providing the modified operational schedule to the first irrigation head includes preventing operation of the first irrigation head during a forecasted precipitation period.

In another form, the method further includes wirelessly providing information regarding operation of the first irrigation head from a number of sensors positioned in an irrigation zone of the first irrigation head.

In one aspect of this form, the information regarding operation of the first irrigation head includes an amount of water detected at each of the sensors during an operational period of the first irrigation head.

In another aspect of this form, the method further includes changing at least one operational aspect of the first irrigation head in response to the information.

In another form, the method further includes controlling operation of one or more LED lights of the first irrigation head.

In one aspect of this form, the one or more LED lights are positioned to illuminate a spray pattern provided by the first irrigation head.

In some embodiments, the different components, modules, engines, and services described herein may be implemented as objects or processes that execute on a computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An irrigation system, comprising:
a number of irrigation heads, wherein at least a first irrigation head of the number of irrigation heads includes a wireless transceiver;
a program module configured to wirelessly connect with the wireless transceiver of the first irrigation head;
wherein at least one operational aspect of the first irrigation head is controllable by the program module independent of the other irrigation heads of the number of irrigation heads.

2. The irrigation system of claim 1, wherein the program module is configured to wirelessly connect with the wireless transceiver by a Wi-Fi or Bluetooth connection.

3. The irrigation system of claim 1, wherein the at least one operational aspect of the first irrigation head includes one or more of a duration of operation of the first irrigation head, lateral limits of a spray pattern, a degree of pitch of the spray pattern, water pressure applied to the first irrigation head, and an operation schedule of the first irrigation head.

4. The irrigation system of claim 3, wherein the operation schedule restricts operation of the first irrigation head during one or more specified periods of time.

5. The irrigation system of claim 1, wherein the wireless transceiver of the first irrigation head is configured to transmit a leak notification in response to detection of a leak associated with the first irrigation head.

6. The system of claim 5, wherein the wireless transceiver of the first irrigation head is configured to transmit the leak notification to the program module, and the program module is configured to terminate water supply to the first irrigation head in response to receiving the leak notification.

7. The irrigation system of claim 1, wherein the program module is configured to communicate with a weather forecasting module and provide a modified operational schedule to the first irrigation head based on forecasted weather reports.

8. The irrigation system of claim 7, wherein the modified operational schedule prevents operation of the first irrigation head during a forecasted precipitation period.

9. The irrigation system of claim 1, further comprising a number of sensors configured to wirelessly communicate with at least one of the first irrigation head and the program module to provide information regarding operation of the first irrigation head.

10. The irrigation system of claim 9, wherein the information regarding operation of the first irrigation head includes an amount of water detected at each of the sensors during an operational period of the first irrigation head.

11. The irrigation system of claim 10, wherein the program module is further configured to change the at least one operational aspect of the first irrigation head in response to the information.

12. The irrigation system of claim 1, wherein the at least one operational aspect of the first irrigation head is coverage area provided by the first irrigation head, and wherein the coverage area is determined in response to a laser gridding performed in connection with the first irrigation head.

13. The irrigation system of claim 1, wherein the first irrigation head includes one or more LED lights and the at least one operational aspect of the first irrigation head includes operation of the one or more LED lights.

14. The irrigation system of claim 13, wherein the one or more LED lights are positioned to illuminate a spray pattern provided by the first irrigation head.

15. A method, comprising:
identifying a first irrigation head from a number of irrigation heads;
determining at least one operational aspect of the first irrigation head;
wirelessly communicating with the first irrigation head and providing the determined at least one operational aspect of the first irrigation head to the first irrigation head; and
operating the first irrigation head in accordance with the determined at least one operational aspect of the first irrigation head.

16. The method of claim 15, wherein determining the at least one operational aspect of the first irrigation head includes:
applying a laser grid to an area adjacent to the first irrigation head during operation of the first irrigation head;
identifying from the laser grid one or more areas where irrigation from the first irrigation head is absent or below a predetermined value; and
changing one or more operational aspects of the first irrigation head to provide or increase irrigation to the one or more identified areas.

17. The method of claim 15, wherein providing the determined at least one operational aspect of the first irrigation head to the first irrigation head includes at least one of controlling a duration of operation of the first irrigation head, controlling lateral limits of a spray pattern, controlling a degree of pitch of the spray pattern, adjusting water pressure applied to the first irrigation head, controlling an operation schedule of the first irrigation head, providing a modified operational schedule to the first irrigation head based on forecasted weather reports, and controlling operation of one or more LED lights of the first irrigation head.

18. The method of claim 17, wherein controlling the operation schedule of the first irrigation head includes restricting operation of the first irrigation head during one or more specified periods of time.

19. The method of claim 17, wherein providing the modified operational schedule to the first irrigation head includes preventing operation of the first irrigation head during a forecasted precipitation period.

20. The method of claim 15, further comprising detecting with the first irrigation head a leak associated with the first irrigation head and transmitting a leak notification in response to detecting the leak associated with the first irrigation head.

21. The method of claim 20, further comprising terminating water supply to the first irrigation head in response to detecting the leak associated with the first irrigation head.

22. The method of claim 15, further comprising wirelessly providing information regarding operation of the first irrigation head from a number of sensors positioned in an irrigation zone of the first irrigation head.

23. The method of claim 22, wherein the information regarding operation of the first irrigation head includes an amount of water detected at each of the sensors during an operational period of the first irrigation head.

24. The method of claim 23, further comprising changing at least one operational aspect of the first irrigation head in response to the information.

25. The method of claim 17, wherein the one or more LED lights are positioned to illuminate a spray pattern provided by the first irrigation head.
